(19) United States
(12) Patent Application Publication
(10) Pub. No.: US 2012/0154691 A1
(43) Pub. Date: Jun. 21, 2012

(54) LIGHTING DEVICE, DISPLAY DEVICE AND TELEVISION RECEIVER

(75) Inventor: Shiyoshi Cho, Osaka-shi (JP)

(73) Assignee: SHARP KABUSHIKI KAISHA, Osaka-shi, Osaka (JP)

(21) Appl. No.: 13/393,554

(22) PCT Filed: Jun. 25, 2010
(86) PCT No.: PCT/JP2010/060814

§ 371 Date: Mar. 1, 2012

(30) Foreign Application Priority Data
Sep. 15, 2009 (JP) 2009-213409

(51) Int. Cl. H04N 5/66; G09F 13/14

(52) U.S. Cl. 348/739; 362/97.1; 362/97.2; 348/E05.133

(57) ABSTRACT

A backlight unit includes hot cathode tubes; a chassis 14 housing the hot cathode tube therein and from which light from the hot cathode tube exits; a diffuser plate; and a reflection sheet 20 facing the diffuser plate in the chassis 14. The hot cathode tubes include at least a first hot cathode tube relatively close to the diffuser plate and a second hot cathode tube relatively far from the diffuser plate. A distance between the first hot cathode tube and the diffuser plate is different from a distance between the second hot cathode tube and the diffuser plate. The backlight unit further includes a directional reflection surface provided on a portion of the reflection member that does not overlap at least the second hot cathode tube, and the directional reflection surface faces toward a portion of the diffuser plate overlapping with the second hot cathode tube.

### TECHNICAL FIELD

The present invention relates to a lighting device, a display device and a television receiver.

### BACKGROUND ART

For example, a liquid crystal panel used for a liquid crystal display device such as a liquid crystal television set does not emit light by itself, and therefore, requires a separate backlight unit as a lighting device. The backlight unit is set on a back side (a side opposite to a display surface) of the liquid crystal panel. The backlight unit includes a chassis having a liquid crystal panel side surface with an opening portion, a light source (cold cathode tube and the like) housed in the chassis, an optical member (a diffuser sheet and the like) arranged in the opening portion of the chassis to efficiently discharge light emitted by the light source to the liquid crystal panel side, and a reflection sheet laid in the chassis to reflect the light from the light source to the optical member and the liquid crystal panel side. A backlight unit described in the following Patent Document 1 has been known as an example disclosing this kind of backlight unit.

Patent Document 1: Japanese Unexamined Patent Publication No. 2006-146126

### Problem to be Solved by the Invention

The number of components is preferably reduced in order to reduce manufacturing cost required for the liquid crystal display device. For example, reduction in the number of light sources to be set in the backlight unit may be required. However, because an area where the light source is not provided in the chassis is increased when the number of the light sources of the backlight unit is simply reduced, an amount of light made incident to the optical member is varied within the surface. As a result, disadvantageously, uneven brightness is visually recognized.

### DISCLOSURE OF THE PRESENT INVENTION

The present invention was completed in view of the foregoing circumstances. It is an object of the present invention to suppress uneven brightness.

### Means for Solving the Problem

A lighting device of the present invention includes light sources, a chassis configured to house the light source therein and from which light from the light source exits, an optical member provided on a light output side with respect to the light source, and a reflection member provided to face the optical member in the chassis and configured to reflect the light. The light sources include at least a short-distance light source relatively close to the optical member and a long-distance light source relatively far from the optical member, and a distance between the short-distance light source and the optical member is different from that between the long-distance light source and the optical member. The lighting device further includes a directional reflection surface provided on a portion of the reflection member that does not overlap with at least the long-distance light source, and the directional reflection surface faces toward a portion of the optical member overlapping with the long-distance light source.

Because the short-distance light source is relatively closer to the optical member than the long-distance light source, an amount of light directly made incident from the short-distance light source to the portion of the optical member overlapping with the short-distance light source is increased, and thereby high brightness is obtained. On the other hand, because the long-distance light source is relatively far from the optical member than the short-distance light source, brightness of the portion of the optical member overlapping with the long-distance light source is lower than that of the portion overlapping with the short-distance light source. However, the brightness is higher than that of the portion not overlapping with each light source. Therefore, a contrast between the portion of the optical member overlapping with the short-distance light source and the portion overlapping with the long-distance light source is less likely to caused, and uneven brightness can be suppressed to some extent.

However, the amount of light made incident to the optical member in the portion of the optical member overlapping with the long-distance light source is less than that in the portion overlapping with the short-distance light source. Therefore, it is undeniable that the contrast between the portion of the optical member overlapping with the short-distance light source and the portion overlapping with the long-distance light source exists. Improvement may be achieved in uneven brightness.

Then, in the present invention, the directional reflection surface facing toward the portion of the optical member overlapping with the long-distance light source is provided on at least the portion of the reflection member that does not overlap with the long-distance light source. The directional reflection surface is provided on at least the portion of the reflection member that does not overlap with the long-distance light source. Therefore, the light from the short-distance light source can be reflected by the directional reflection surface, and the reflected light can be directed toward the portion of the optical member overlapping with the long-distance light source. Thereby, the amount of light which tends to be insufficient in the portion of the optical member overlapping with the long-distance light source can be complemented. Therefore, the contrast which may be generated between the portion of the optical member overlapping with the short-distance light source and the portion overlapping with the long-distance light source is less likely to be caused, and thereby generation of uneven brightness can be effectively suppressed.

### BRIEF DESCRIPTION OF THE DRAWINGS

FIG. 1 is an exploded perspective view showing a schematic configuration of a television receiver according to a first embodiment of the present invention;

FIG. 2 is an exploded perspective view showing a schematic configuration of a liquid crystal display device provided in the television receiver;

FIG. 3 is a sectional view showing a sectional configuration along a short side direction of the liquid crystal display device;

FIG. 4 is a sectional view showing a sectional configuration along a long side direction of the liquid crystal display device;

FIG. 5 is a plan view showing an arranging configuration of a hot cathode tube and a reflection sheet in a chassis included in the liquid crystal display device;

FIG. 6 is an enlarged sectional view of a main part of FIG. 3;

FIG. 7 is a sectional view of a liquid crystal display device along a short side direction according to a first modification example of the first embodiment;

FIG. 8 is a sectional view of a liquid crystal display device along a short side direction according to a second modification example of the first embodiment;

FIG. 9 is a sectional view of a liquid crystal display device along a short side direction according to a third modification example of the first embodiment;

FIG. 10 is a sectional view of a liquid crystal display device along a short side direction according to a second embodiment of the present invention;

FIG. 11 is a sectional view of a liquid crystal display device along a short side direction according to a first modification example of the second embodiment;

FIG. 12 is a sectional view of a liquid crystal display device along a short side direction according to a third embodiment of the present invention;

FIG. 13 is a plan view showing an arranging configuration of an LED board and a reflection sheet in a chassis according to a fourth embodiment of the present invention;

FIG. 14 is a xiv-xiv line sectional view of FIG. 13; and

FIG. 15 is a xv-xv line sectional view of FIG. 13.

### BEST MODE FOR CARRYING OUT THE INVENTION

### First Embodiment

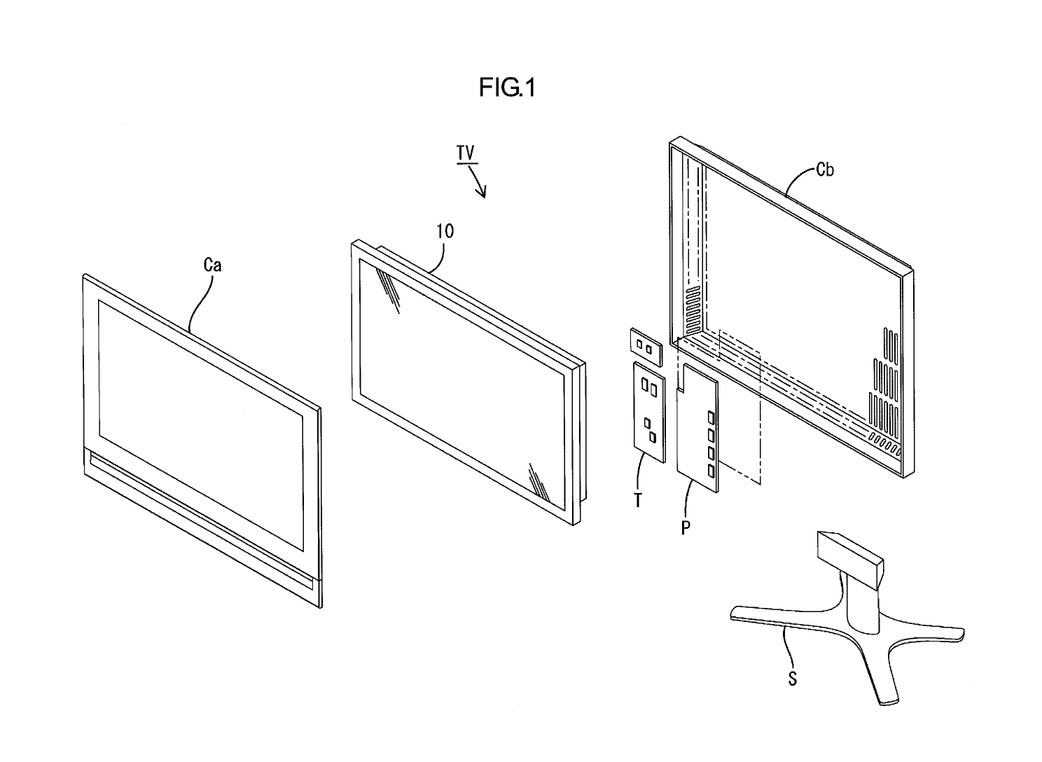

A first embodiment of the present invention will be described with reference to FIGS. 1 to 6. First, a configuration of a television receiver TV including a liquid crystal display device 10 will be described.

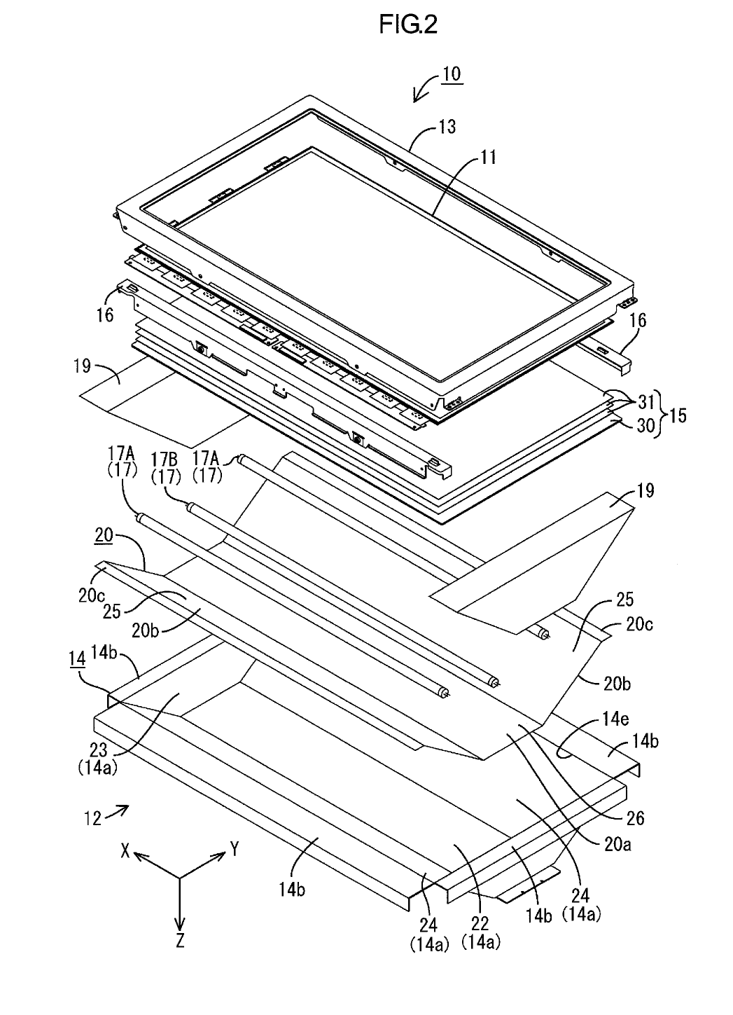

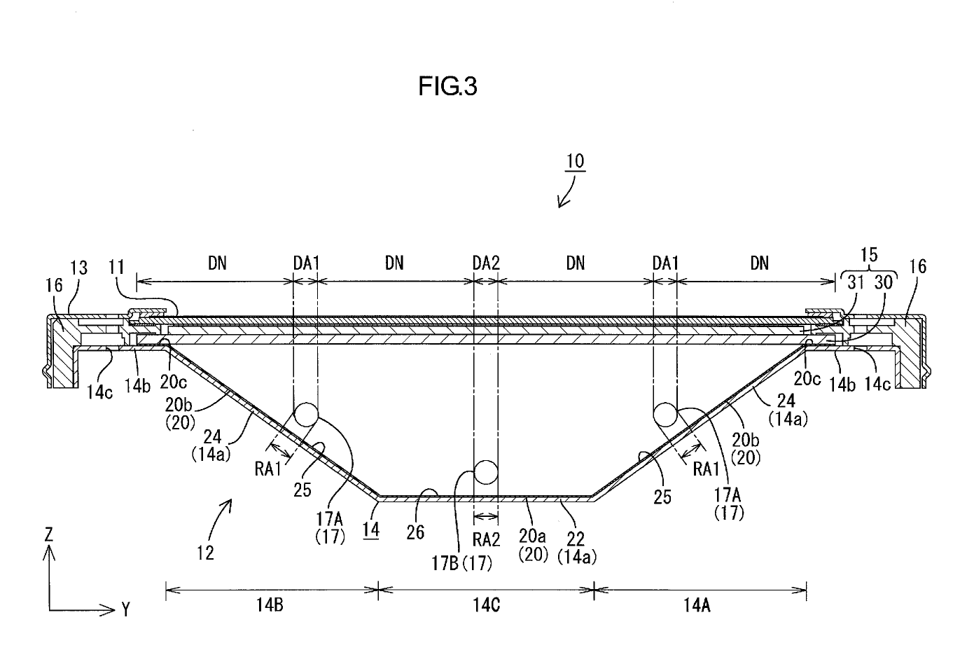

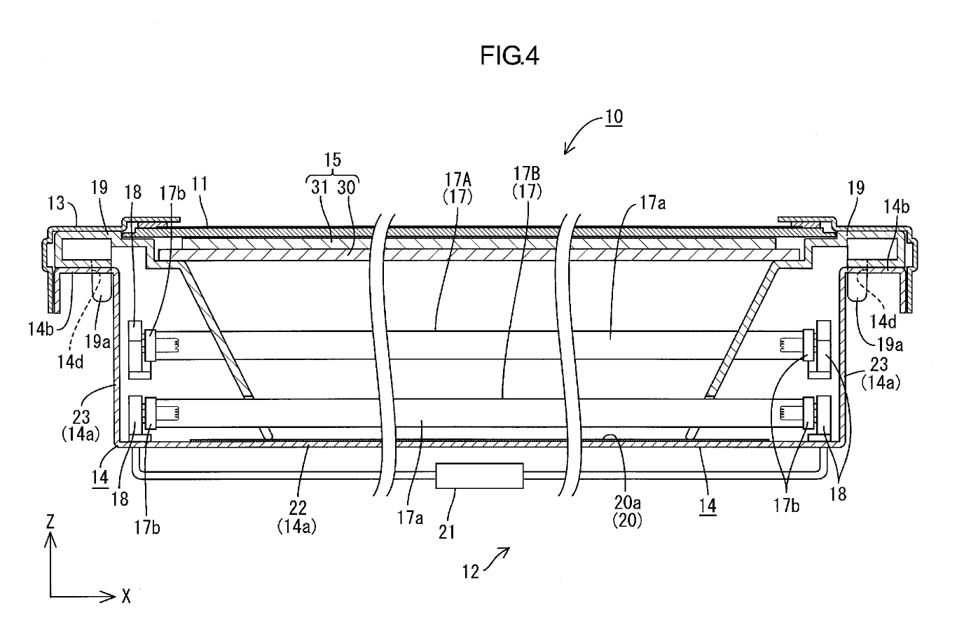

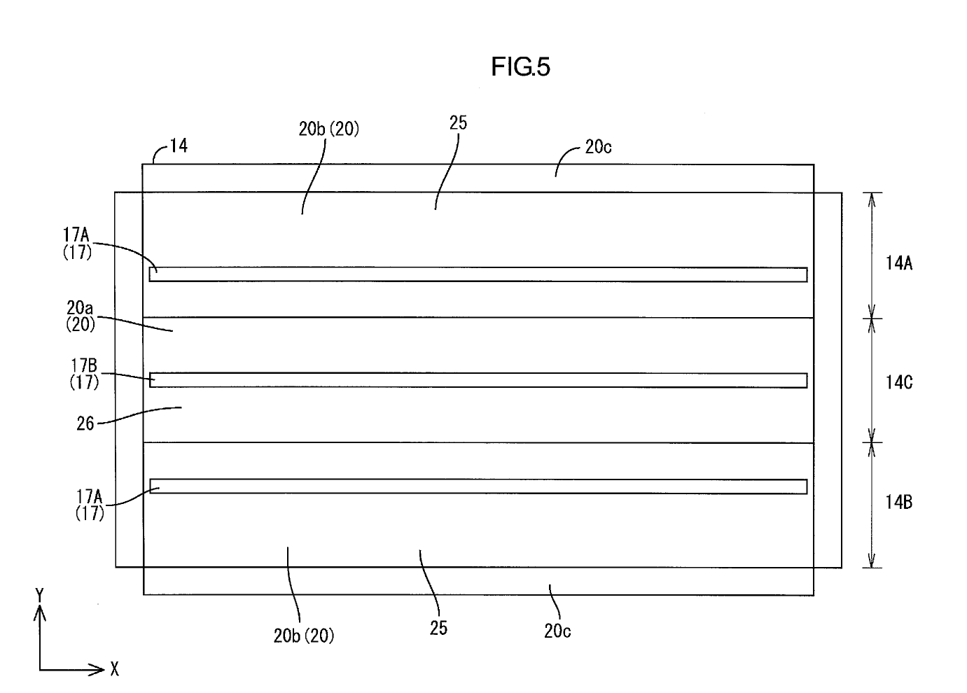

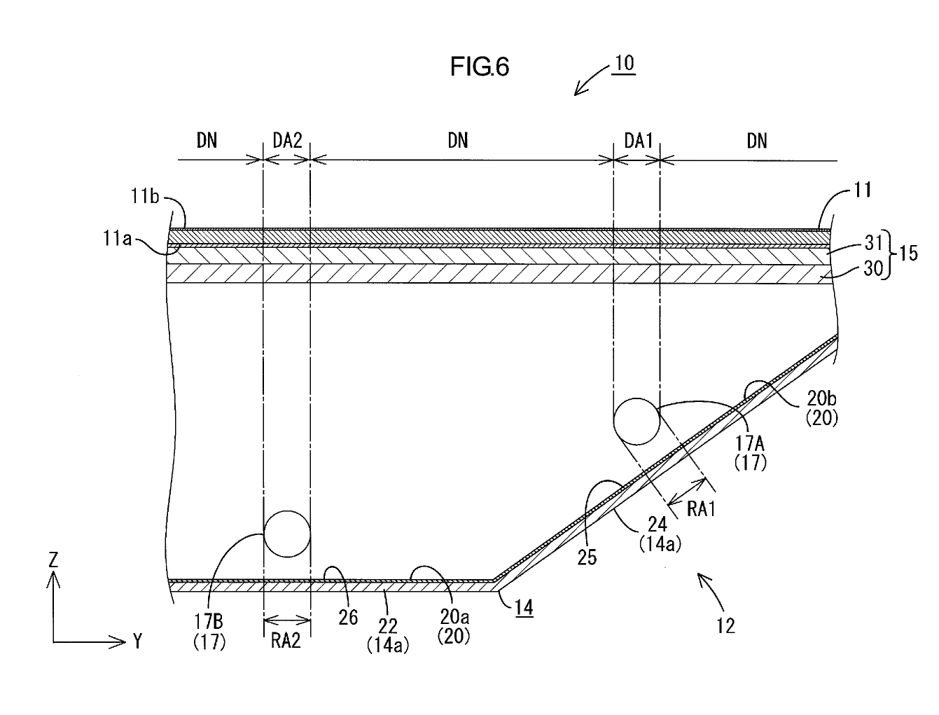

FIG. 1 is an exploded perspective view showing a schematic configuration of a television receiver of the present embodiment. FIG. 2 is an exploded perspective view showing a schematic configuration of a liquid crystal display device provided in the television receiver of FIG. 1. FIG. 3 is a sectional view showing a sectional configuration along a short side direction of the liquid crystal display device of FIG. 2. FIG. 4 is a sectional view showing a sectional configuration along a long side direction of the liquid crystal display device of FIG. 2. FIG. 5 is a plan view showing an arranging configuration of a hot cathode tube and a reflection sheet in a chassis included in the liquid crystal display device of FIG. 2. FIG. 6 is an enlarged sectional view of an essential part of FIG. 3. In FIG. 5, a long side direction of the chassis is defined as an X-axis direction, and a short side direction thereof is defined as a Y axis direction.

A television receiver TV according to this embodiment includes, as shown in FIG. 1, the liquid crystal display device 10, front and back cabinets Ca, Cb that house the liquid crystal display device 10 therebetween, a power source P, a tuner T and a stand S. An entire shape of the liquid crystal display device (display device) 10 is a landscape rectangle (rectangular, longitudinal). The liquid crystal display device 10 is housed in a vertical position. As shown in FIG. 2, the liquid display device 10 includes a liquid crystal panel 11 as a display panel, a backlight unit (lighting device) 12 as an external light source. The liquid crystal panel 11 and the backlight unit 12 are integrally held by the frame-like bezel 13 and the like. In the present embodiment, the liquid crystal display device 10 having a screen size of 32 inches and an aspect ratio of 16:9 is exemplified. More specifically, a horizontal size (a size in the X-axis direction) of a screen is, for example, about 698 mm, and a vertical size (a size in the Y axis direction) thereof is, for example, about 392 mm.

Next, the liquid crystal panel 11 and the backlight unit 12 included in the liquid crystal display device 10 will be described (see FIGS. 2 to 4).

The liquid crystal panel (display panel) 11 is configured such that a pair of glass substrates is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, and an alignment film and the like are provided. On the other glass substrate, color filters having color sections such as R (red), G (green) and B (blue) color sections arranged in a predetermined pattern, counter electrodes, and an alignment film and the like are provided. Polarizing plates 11a and 11b are attached to outer surfaces of the substrates (see FIGS. 3 and 4).

As shown in FIG. 2, the backlight unit 12 includes a chassis 14, an optical member 15 set (diffuser plate (optical diffusion member) 30, and a plurality of optical sheets 31 which are provided between the diffuser plate 30 and the liquid crystal panel 11), and a frame 16. The chassis 14 has a substantially box-shape, and has an opening portion 14e on the front side (the light output side, the liquid crystal panel 11 side). The optical sheet set 15 is provided so as to cover the opening portion 14e of the chassis 14. The frame 16 is provided along a long side of the chassis 14 and holds a long side edge portion of the optical member 15 set in a state where the long side edge portion is sandwiched between the frame 16 and the chassis 14. Furthermore, hot cathode tubes 17 as light sources (line light sources), sockets 18 bearing relay of electrical connection in the end portions of the hot cathode tubes 17, and holders 19 collectively covering the end portions of the hot cathode tubes 17 and the sockets 18 are arranged in the chassis 14. Moreover, a reflection sheet 20 reflecting light is laid in the chassis 14. In the backlight unit 12, a light output side of the backlight unit 12 is a side closer to the optical member 15 than the hot cathode tube 17.

The chassis 14 is made of a synthetic resin. As shown in FIGS. 3 and 4, the chassis 14 includes a housing portion 14a having an opened front side surface and having a substantially box-shape, and a receiving plate 14b outwardly overhanging from each outer edge portion in the housing portion 14a. The housing portion 14a includes a bottom plate 22 that is parallel to a plate surface of the optical member 15, and side plates 23 and 24 rising to the front side from end portions in each side of the bottom plate 22. The bottom plate 22 has a rectangular shape (elongated shape) such that the bottom plate 22 aligns with the liquid crystal panel 11 and the optical member 15 in a long side direction and a short side direction. The bottom plate 22 has a long side having the almost same size as those of the liquid crystal panel 11 and the optical member 15. However, the bottom plate 22 has a short side having a size smaller than those of the liquid crystal panel 11 and the optical member 15. A pair of short side plates 23 of the side plates 23 and 24 rises from bottom plate 22 at substantially right angles (FIG. 4). By contrast, a pair of long side plates 24 rises from bottom plate 22 in an inclined manner at a predetermined angle (FIG. 3). A rising angle of both the long side plates 24 from the bottom plate 22 is set to an acute angle (90 degrees or less). Therefore, the bottom plate 22 and the pair of long side plates 24 provided so as to sandwich the bottom plate 22 in the housing portion 14a are opposite to the optical member 15. When the chassis 14 is segmented into a first end portion 14A, a second end portion 14B located at an end opposite to the first end portion 14A, and a center portion 14C sandwiched therebetween, in the short side direction (Y axis direction), the center portion 14C corresponds to the bottom plate 22, and the first end portion 14A and the second end portion 14B correspond to the long side plates 24. Insertion holes into which the sockets 18 are inserted are made in both the ends of the long side direction of the bottom plate 22 and the long side plates 24.

Because the long side plates 24 rise to the front side from the bottom plate 22, a dead space is generated on the back side thereof. For example, a control board (not shown) and the like configured to drive an inverter board 21 and the liquid crystal panel 11 can be arranged on the back side of the long side plates 24 utilizing the dead space. Therefore, the entire thickness of the liquid crystal display device 10 (backlight unit 12) can be reduced.

The receiving plate 14b outwardly extends from a rising end of each of the side plates 23 and 24, and is parallel to the bottom plate 22. The outer edge portions of the reflection sheet 20 and the optical member 15 are placed on the receiving plate 14b. The receiving plate 14b can receive the reflection sheet 20 and the optical member 15 from the back side. As shown in FIG. 3, fixing holes 14c are made in the receiving plate 14b, for example, to bind a bezel 13, the frame 16 and the chassis 14 and the like together with screws and the like.

The reflection sheet 20 is made of a synthetic resin (for example, made of foamed PET), and has a white surface that provides excellent light reflectivity. As shown in FIG. 2, the reflection sheet 20 is provided on an inner surface side (a surface side facing the hot cathode tube 17) of the chassis 14 to cover the almost entire chassis 14. The reflection sheet 20 is opposite to the optical member 15 and the hot cathode tubes 17, and can reflect light emitted from hot cathode tubes 17 to the optical member 15 side. The reflection sheet 20 has a rectangular shape (elongated shape) such that the reflection sheet 20 aligns with the chassis 14 in the long side direction and the short side direction as a whole. The reflection sheet 20 has a symmetrical shape in the short side direction.

The reflection sheet 20 includes a bottom portion 20a provided along the bottom plate 22 in the chassis 14, a pair of rising portions 20b rising to the front side (the light output side, the optical member 15 side) from ends of the bottom portion 20a and provided along the long side plates 24 in the chassis 14, and a pair of extending portions 20c outwardly extending from rising tip portions (ends opposite to the bottom portion 20a side) in the rising portions 20b.

As shown in FIGS. 3 and 5, the bottom portion 20a has almost the same plan view size as that of the bottom plate 22 in the chassis 14. The bottom portion 20a and the bottom plate 22 are overlapping with each other in a plan view. That is, the bottom portion 20a is provided in a position where the bottom portion 20a is overlapping with and is aligned to the center portion 14C of the short side direction in the chassis 14 in a plan view. The bottom portion 20a is parallel to a plate surface of the bottom plate 22. The bottom portion 20a has a rectangular shape (elongated shape). The long side direction thereof corresponds to the X-axis direction (the long side direction of the chassis 14, the axial direction of the hot cathode tube 17). The short side direction thereof corresponds to the Y axis direction (the short side direction of the chassis 14).

The pair of rising portions 20b is provided so as to sandwich the bottom portion 20a therebetween in the short side direction. The rising portions 20b have almost the same plan view size as those of the long side plates 24 in the chassis 14. The rising portions 20b and the long side plates 24 are overlapping with each other in a plan view. That is, the rising portions 20b rise from two ends of the long side of the bottom portion 20a, respectively in opposite directions. The rising portions 20b are provided so as to overlap and correspond to the first end portion 14A and the second end portion 14B, respectively in the short side direction of the chassis 14 in a plan view. The rising portions 20b are inclined to have a constant inclination from a rising base end (an end on the bottom portion 20a side) to a rising tip portion (an end opposite to the bottom portion 20a side (on the extending portion 20c side)). Each of the rising portions 20b has a plate surface inclined with respect to the Y axis direction and the Z axis direction, that is, a plate surface of the bottom portion 20a. Therefore, a space generated between the rising portions 20b and the facing diffuser plate 30 is smaller as going to the end sides from the center side (toward a direction away from the center second hot cathode tube 17B) in the Y axis direction. The rising angle of the rising portion 20b from the bottom portion 20a (an inclined angle between each rising portion 20b and the plate surface of the bottom portion 20a, an angle made by the rising portion 20b with respect to the Y axis direction) is set to an acute angle (90 degrees or less). The rising angle of the rising portions 20b is almost equal to the rising angle of the long side plate 24 from the bottom plate 22 of the chassis 14. Therefore, the rising portions 20b are parallel to the plate surfaces of the long side plates 24 of the chassis 14. A bending position of the rising portions 20b from the bottom portion 20a substantially corresponds to that of the long sideplate 24 from the bottom plate 22. Thereby, the bottom portion 20a is provided on the bottom plate 22 having substantially no space therebetween, and the rising portions 20b are provided on the long side plates 24 having substantially no space therebetween. Therefore, the shape of the reflection sheet 20 is maintained. In other words, the housing portion 14a of the chassis 14 is formed in a shape (bending shape) following the outer shape formed by the bottom portion 20a and the rising portion 20b of the reflection sheet 20.

The extending portions 20c outwardly extend from the rising tip portions of the rising portions 20b respectively and are provided to overlap with the receiving plates 14b of the chassis 14 in a plan view. The extending portions 20c are parallel to the plate surface of the bottom portion 20a (the bottom plate 22 and the receiving plate 14b), and are laid on front side surface of the receiving plates 14b. Each of the extending portions 20c is sandwiched between the receiving plate 14b and an outer edge portion of the diffuser plate 30.

As shown in FIG. 2, like the liquid crystal panel 11 and the chassis 14, the optical member 15 has a landscape shape (rectangular) in a plan view. The optical member 15 is interposed between the liquid crystal panel 11 and the hot cathode tubes 17. The optical member 15 includes the diffuser plate 30 provided on the back side (the hot cathode tube 17 side, the side opposite to the light output side), and an optical sheet 31 provided on the front side (the liquid crystal panel 11 side, the light output side). The diffuser plate 30 is provided to directly face the hot cathode tubes 17 and the reflection sheet 20. The diffuser plate 30 includes substantially a transparent resin base material having a predetermined thickness, and numerous diffusing particles dispersed in the base material. The diffuser plate 30 has a function to diffuse transmitting light. The optical sheet 31 is formed into a sheet having a plate thickness thinner than a thickness of the diffuser plate 30. The optical sheet 31 is configured by laminating three sheets. Specifically, the optical sheet 31 includes a diffuser sheet, a lens sheet, and a reflection type polarizing sheet in order from the diffuser plate 30 side (back side).

As shown in FIGS. 3 and 4, each of the hot cathode tubes 17 has a tube (line) shape as a whole, and includes a hollow glass tube 17a, and a pair of electrodes 17b provided on both ends of the glass tube 17a. Mercury and rare gas or the like enclosed in the glass tube 17a and a fluorescent material is coated on an inner wall surface of the glass tube 17a. A light-emitting surface of the hot cathode tube 17 is an outer circumferential surface of the glass tube 17a, and light is emitted radially from an axial core of the glass tube 17a. Each electrode 17b includes a filament and a pair of terminals connected to both ends of the filament. The sockets 18 (connector) are respectively externally fitted to both ends of the hot cathode tube 17. The above-mentioned terminal is connected to the inverter board 21 attached to the outer surface side (back side) of bottom plate 22 of the chassis 14 via the socket 18. Driving power is supplied to the hot cathode tube 17 from the inverter board 21, and a tube current value, that is, brightness (lighting state) can be controlled by the inverter board 21. The hot cathode tubes 17 are interposed between the diffuser plate 30 and the bottom portion 20a (the bottom plate 22 of the chassis 14) of the reflection sheet 20. The hot cathode tubes 17 are provided closer to the bottom portion 20a of the reflection sheet 20 than the diffuser plate 30. The sockets 18 are fixed and mounted to the bottom plate 22 of the chassis 14, and thereby a distance between each hot cathode tube 17 and the diffuser plate 30 and a distance between the hot cathode tube 17 and the bottom portion 20a of the reflection sheet 20 are constantly maintained. An outer diameter size of the hot cathode tube 17 is larger than an outer diameter size (for example, about 4 mm) of the cold cathode tube, and, for example, is set to about 15.5 mm.

The holder 19 covering the end of the hot cathode tubes 17 and the sockets 18 is made of a white synthetic resin. As shown in FIG. 2, the holder 19 has a substantially long box-shape extending along the short side direction of the chassis 14. As shown in FIG. 4, the holder 19 has a stepped surface on which the optical member 15 and the liquid crystal panel 11 can be laid in completely different levels on the surface side. The holder 19 is provided to partially overlap with the receiving plate 14b in the short side direction of the chassis 14. The holder 19 and the receiving plate 14b form a side wall of the backlight unit 12. An insertion pin 19a is projected from a surface of the holder 19 facing the receiving plate 14b of the chassis 14. The insertion pin 19a is inserted into an insertion hole 14d formed in an upper surface of the receiving plate 14b of the chassis 14, and thereby the holder 19 is attached to the chassis 14.

As shown in FIGS. 3 and 5, three hot cathode tubes 17 having the above-mentioned structure are housed in the chassis 14 with a length direction (axial direction) thereof aligned with the long side direction of the chassis 14. A distance between each of the three hot cathode tubes 17 and the diffuser plate 30 is set to two different distances. Hereinafter, first hot cathode tubes 17A (short-distance light source) are relatively close (a distance from the diffuser plate 30 is small) to the diffuser plate 30. A second hot cathode tube 17B (long-distance light source) is relatively far (a distance from the diffuser plate 30 is great) from the diffuser plate 30. When the hot cathode tube 17 is generally referred without distinguishing the hot cathode tube 17 according to the distance from the diffuser plate 30, indexes A and B are not applied to the hot cathode tube 17.

As shown in FIG. 3, the first hot cathode tubes 17A are arranged so as to respectively correspond to the first end portion 14A and the second end portion 14B of the housing portion 14a of the chassis 14. That is, the first hot cathode tubes 17A are symmetrically arranged in positions sandwiching the center portion 14C in the housing portion 14a of the chassis 14. The two first hot cathode tubes 17A are attached to both the long side plates 24 corresponding to the first end portion 14A and the second end portion 14B via the sockets 18. The region of the diffuser plate 30 overlapping with each first hot cathode tube 17A described above is defined as a first light source overlapping portion DA1 (short-distance light source overlapping portion). As shown in FIG. 6, the first light source overlapping portion DA1 is a portion of the diffuser plate 30 overlapping with the first hot cathode tube 17A in a direction perpendicular to a plate surface thereof, that is, the Z axis direction.

On the other hand, as shown in FIG. 3, the second hot cathode tube 17B is provided so as to correspond to the center portion 14C of the housing portion 14a of the chassis 14. The second hot cathode tube 17B is provided in a center position in the Y axis direction of the center portion 14C. Distances from the second hot cathode tube 17B to each of the first hot cathode tubes 17A located on the side are almost equal to each other. Because the second hot cathode tube 17B is provided to be relatively closer to the back side from the first hot cathode tube 17A, a line connecting centers of the second hot cathode tube 17B and the first hot cathode tube 17A is inclined with respect to both the Y axis direction and the Z axis direction. The line has a slope generally following the long side plate 24 and the rising portion 20b. The second hot cathode tube 17B is attached to the bottom plate 22 corresponding to the center portion 14C via the sockets 18. In this context, the socket 18 is the attaching structure of each hot cathode tube 17 to the chassis 14. The same type of sockets 18 are used for the first hot cathode tube 17A and the second hot cathode tube 17B. Therefore, a distance between the first hot cathode tube 17A and the rising portion 20b (side plate 24) in the attaching state is almost equal to a distance between the second hot cathode tube 17B and the bottom portion 20a (bottom plate 22). The above-mentioned region of the diffuser plate 30 overlapping with the second hot cathode tube 17B is defined as a second light source overlapping portion DA2 (long-distance light source overlapping portion). As shown in FIG. 6, the second light source overlapping portion DA2 is a portion of the diffuser plate 30 overlapping the second hot cathode tube 17B in a direction perpendicular to a plate surface thereof, that is, the Z axis direction. A portion of the diffuser plate 30 except the first light source overlapping portion DA1 and the second light source overlapping portion DA2 is defined as a light source non-overlapping portion DN which is not overlapping with the hot cathode tube 17.

As described above, the distance between the first hot cathode tube 17A and the diffuser plate 30 is different from the distance between the second hot cathode tube 17B and the diffuser plate 30. The reflection sheet 20 is provided as follows for the first hot cathode tube 17A and the second hot cathode tube 17B. That is, as shown in FIG. 3, each rising portion 20b of the reflection sheet 20 is provided so as to be overlapping with each first hot cathode tube 17A relatively close to the diffuser plate 30. On the other hand, the bottom portion 20a of the reflection sheet 20 is provided so as to be overlapping with the second hot cathode tube 17B relatively far from the diffuser plate 30. Therefore, each rising portion 20b has a first light source overlapping reflection portion RA1 (short-distance light source overlapping reflection portion) overlapping with each first hot cathode tube 17A. On the other hand, the bottom portion 20a has a second light source overlapping reflection portion RA2 (long-distance light source overlapping reflection portion) overlapping with the second hot cathode tube 17B. As shown in FIG. 6, the first light source overlapping reflection portion RA1 is a portion overlapping with the first hot cathode tube 17A in a direction perpendicular to the plate surface of the rising portion 20b, that is, a direction inclined by the inclined angle of the rising portion 20b with respect to the Z axis direction. The second light source overlapping reflection portion RA2 is a portion overlapping with the second hot cathode tube 17B in a direction perpendicular to the plate surface of the bottom portion 20a, that is, the Z axis direction.

A front side surface of each rising portion 20b is inclined with respect to the plate surface of the diffuser plate 30, and faces the second light source overlapping portion DA2 of the diffuser plate 30. The front side surface is defined as a directional reflection surface 25. Light is reflected by the directional reflection surface 25, and thereby the reflected light can be made incident to the second light source overlapping portion DA2 side of the diffuser plate 30. On the other hand, a front side surface of the bottom portion 20a is parallel to the plate surface of the diffuser plate 30, and is opposed to (face) the second light source overlapping portion DA2 located at the front of the diffuser plate 30. The front side surface is defined as a parallel reflection surface 26.

The directional reflection surface 25 extends over a range that includes the first light source overlapping reflection portion RA1 and is larger than the first light source overlapping reflection portion RA1. That is, the directional reflection surface 25 ranges almost the entire region of the rising portion 20b. Arising angle of the directional reflection surface 25 from the parallel reflection surface 26 is an acute angle. The reflected light can be angled based on the above-mentioned rising angle. Therefore, the directional reflection surface 25 can mainly reflect light emitted to the back side from the first hot cathode tube 17A, to the front side. The directional reflection surface 25 can direct the reflected light toward the second light source overlapping portion DA2 rather than first light source overlapping portion DA1 of the diffuser plate 30, that is, the center side of the Y axis direction.

The parallel reflection surface 26 extends over a range which includes the second light source overlapping reflection portion RA2 and is larger than the second light source overlapping reflection portion RA2. The parallel reflection surface 26 ranges almost the entire region of the bottom portion 20a. The parallel reflection surface 26 can mainly reflect light emitted to the back side from the second hot cathode tube 17B, to the front side. The parallel reflection surface 26 can make the reflected light incident to the second light source overlapping portion DA2 of the diffuser plate 30 facing the front. Thus, portions of the reflection sheet 20 (the bottom portion 20a and the rising portion 20b) exhibiting a light reflection function in the chassis 14 can collect the reflected light to the second light source overlapping portion DA2 (the center of the Y axis direction) side of the diffuser plate 30.

This embodiment has the above-mentioned configuration, and its operations will be described. When the hot cathode tube 17 is lighted when the liquid crystal display device 10 is used, the light emitted from the hot cathode tube 17 is directly made incident to the diffuser plate 30, or is reflected by members (the holder 19 and the reflection sheet 20 or the like) provided in the chassis 14, and is then indirectly made incident to the diffuser plate 30. The light is transmitted through the diffuser plate 30, and is then exited toward the liquid crystal panel 11 via the optical sheet 31.

First, direct light made incident to the diffuser plate 30 directly from the hot cathode tube 17 will be described in detail. Because the light emitted from the hot cathode tube 17 spreads radially from the axial core as shown in FIG. 6, an irradiation range of the direct light to the diffuser plate 30 can be changed according to the distance between the hot cathode tube 17 and the diffuser plate 30. That is, the smaller the distance between the diffuser plate 30 and the hot cathode tube 17 is, the smaller the irradiation range of the direct light to the diffuser plate 30 is. On the other hand, the larger the distance is, the larger the irradiation range of the direct light to the diffuser plate 30 is. Therefore, the direct light from the first hot cathode tube 17A relatively close to the diffuser plate 30 is intensively made incident to a relatively small range of the diffuser plate 30 around the first light source overlapping portion DA1. Thereby, an amount of incident light near the first light source overlapping portion DA1 tends to be locally increased. On the other hand, the direct light from the second hot cathode tube 17B relatively far from the diffuser plate 30 is made incident to a relatively large range of the diffuser plate 30 around the second light source overlapping portion DA2 with being diffused. Therefore, an amount of incident light near the second light source overlapping portion DA2 tends to be smaller than that of the first light source overlapping portion DA1. The direct light from the first hot cathode tube 17A and the second hot cathode tube 17B is made incident to the light source non-overlapping portion DN (central light source non-overlapping portion DN) between the second light source overlapping portion DA2 and the first light source overlapping portion DA1 of the diffuser plate 30, to some extent. However, because the direct light from the second hot cathode tube 17B is particularly made incident to a large range of the light source non-overlapping portion DN, distribution of the amount of incident light changes gently from the second light source overlapping portion DA2 side to the first light source overlapping portion DA1 side. That is, the second hot cathode tube 17B is provided relatively far from the diffuser plate 30, and thereby a contrast is less likely to be caused between each of the light source overlapping portions DA1, DA2 and the light source non-overlapping portion DN to some extent.

Next, indirect light indirectly made incident to the diffuser plate 30 from the hot cathode tube 17 will be described in detail. Because the indirect light is the light mostly reflected by the reflection sheet 20 laid over almost the entire region of the chassis 14, the reflected light by the reflection sheet 20 will be described hereinafter. First, the light emitted from the first hot cathode tube 17A and mainly emitted to the back side is reflected by the directional reflection surface 25 of the rising portion 20b. Because the directional reflection surface 25 is inclined with respect to the plate surface of the diffuser plate 30, and is directed toward the center side of the Y axis direction, that is, the second light source overlapping portion DA2 side, the reflected light can be angled. The reflected light can be directed toward and made incident to the second light source overlapping portion DA2 side. The directional reflection surface 25 includes the first light source overlapping reflection portion RA1 of the rising portion 20b overlapping with the first hot cathode tube 17A, and has an area greater than an area of the first light source overlapping reflection portion RA1. Therefore, the light from the first hot cathode tube 17A can be mainly made incident to the second light source overlapping portion DA2 side effectively. The reflected light from the directional reflection surface 25 is made incident to not only the second light source overlapping portion DA2 but also the light source non-overlapping portion DN (central light source non-overlapping portion DN) between the second light source overlapping portion DA2 and the first light source overlapping portion DA1 more than a little.

On the other hand, light emitted from the second hot cathode tube 17B to the back side is mainly reflected by the parallel reflection surface 26 of the bottom portion 20a. Because the parallel reflection surface 26 is parallel to the plate surface of the diffuser plate 30, the reflected light is hardly angled. Thereby, the light reflected by the parallel reflection surface 26 is efficiently made incident to the second light source overlapping portion DA2 without being directed toward the first light source overlapping portion DA1 of the diffuser plate 30. In addition, the parallel reflection surface 26 includes the second light source overlapping reflection portion RA2 of the bottom portion 20a overlapping with the second hot cathode tube 17B, and has overran area greater than an area of the second light source overlapping reflection portion RA2. Therefore, light from the second hot cathode tube 17B can be mainly made incident to the second light source overlapping portion DA2 side effectively. The reflected light from the parallel reflection surface 26 is made incident to not only the second light source overlapping portion DA2 but also the light source non-overlapping portion DN (central light source non-overlapping portion DN) between the second light source overlapping portion DA2 and the first light source overlapping portion DA1 more than a little.

As described above, the indirect light reflected by the directional reflection surface 25 and the parallel reflection surface 26 of the reflection sheet 20 is mostly made incident to the second light source overlapping portion DA2 side of the diffuser plate 30 in which an amount of incident light of the direct light tends to be insufficient. That is, the light reflected by the reflection sheet 20 is collected to the second light source overlapping portion DA2 side of the diffuser plate 30, and thereby the amount of incident light to the second light source overlapping portion DA2 which tends to be insufficient can be complemented. Accordingly, a difference in the total amount of incident light in the diffuser plate 30 including the direct light and the indirect light which may be generated between the first light source overlapping portion DA1 and the second light source overlapping portion DA2 is less likely to be generated. Therefore, the contrast between the first light source overlapping portion DA1 and the second light source overlapping portion DA2 is extremely hardly recognized. In addition, because the total amount of incident light is gently changed to the second light source overlapping portion DA2 side from the first light source overlapping portion DA1 side in the central light source non-overlapping portion DN of the diffuser plate 30, the above-mentioned contrast is further hardly recognized. Furthermore, the second light source overlapping portion DA2 of the diffuser plate 30 corresponds to the center portion of the Y axis direction in the display surface of the liquid crystal display device 10, and the reflected light by reflection sheet 20 is collected to the second light source overlapping portion DA2. Therefore, brightness in the center portion of the display surface can be sufficiently enhanced, and thereby high display quality can be obtained.

As described above, the backlight unit 12 of the embodiment includes the hot cathode tube 17 as the light source, the chassis 14 configured to house the hot cathode tube 17 and from which light from the hot cathode tube 17 exits, the diffuser plate 30 as the optical member provided on the light output side of the hot cathode tube 17, and the reflection sheet 20 provided to face the diffuser plate 30 in the chassis 14 and reflecting the light. The hot cathode tubes 17 are provided to have different distances from the diffuser plate 30. The hot cathode tube 17 includes at least the first hot cathode tube 17A (short-distance light source) relatively close to the diffuser plate 30 and the second hot cathode tube 17B (long-distance light source) relatively far from the diffuser plate 30. The directional reflection surface 25 faces the portion (second light source overlapping portion DA2) of the diffuser plate 30 overlapping with the second hot cathode tube 17B. The directional reflection surface 25 is provided on at least the portion of the reflection sheet 20 that does not overlap with the second hot cathode tube 17B.

Because the first hot cathode tube 17A is relatively closer to the diffuser plate 30 than the second hot cathode tube 17B, an amount of light directly made incident from the first hot cathode tube 17A to the portion (first light source overlapping portion DA1) of the diffuser plate 30 overlapping with the first hot cathode tube 17A is increased, and thereby high brightness is obtained. On the other hand, because the second hot cathode tube 17B is relatively far from the diffuser plate 30 than the first hot cathode tube 17A, brightness of the portion (second light source overlapping portion DA2) of the diffuser plate 30 overlapping with the second hot cathode tube 17B is lower than that on the portion (first light source overlapping portion DA1) overlapping with the first hot cathode tube 17A. However, the brightness is higher than that on the portion (light source non-overlapping portion DN) that does not overlap with each hot cathode tube 17. Therefore, a contrast between the portion (first light source overlapping portion DA1) of the diffuser plate 30 overlapping with the first hot cathode tube 17A and the portion (second light source overlapping portion DA2) overlapping with the second hot cathode tube 17B is less likely to be caused, and uneven brightness can be suppressed to some extent.

However, the amount of light made incident to the diffuser plate 30 is smaller on the portion (second light source overlapping portion DA2) overlapping with the second hot cathode tube 17B than the portion (first light source overlapping portion DA1) overlapping with the first hot cathode tube 17A. Therefore, it is undeniable that the contrast between the portion (first light source overlapping portion DA1) of the diffuser plate 30 overlapping with the first hot cathode tube 17A and the portion (second light source overlapping portion DA2) overlapping with the second hot cathode tube 17B exists. Uneven brightness may be improved more.

Then, in the present embodiment, the directional reflection surface 25 facing the portion (second light source overlapping portion DA2) of the diffuser plate 30 overlapping with the second hot cathode tube 17B is provided on at least the portion of the reflection sheet 20 which does not overlap with the second hot cathode tube 17B. The directional reflection surface 25 is provided on at least the portion of the reflection sheet 20 that does not overlap with the second hot cathode tube 17B. Therefore, for example, the light from the first hot cathode tube 17A reflects off the directional reflection surface 25 and the reflected light can be directed toward the portion (second light source overlapping portion DA2) of the diffuser plate 30 overlapping with the second hot cathode tube 17B. Thereby, the amount of light which tends to be insufficient on the portion (second light source overlapping portion DA2) of the diffuser plate 30 overlapping with the second hot cathode tube 17B can be compensated. Therefore, the contrast which may be generated between the portion (first light source overlapping portion DA1) of the diffuser plate 30 overlapping with the first hot cathode tube 17A and the portion (second light source overlapping portion DA2) overlapping with second hot cathode tube 17B is less likely to be caused. Accordingly, generation of uneven brightness can be effectively suppressed.

The directional reflection surface 25 is provided on at least a portion (first light source overlapping reflection portion RA1) of the reflection sheet 20 overlapping with the first hot cathode tube 17A. Thus, light from the first hot cathode tube 17A can be efficiently reflected by the directional reflection surface 25 provided on at least the portion (first light source overlapping reflection portion RA1) of the reflection sheet 20 overlapping with the first hot cathode tube 17A, and the reflected light can be directed toward the portion (second light source overlapping portion DA2) of the diffuser plate 30 overlapping with the second hot cathode tube 17B. Thereby, the amount of incident light to the portion (second light source overlapping portion DA2) of the diffuser plate 30 overlapping with the second hot cathode tube 17B can be compensated by efficiently utilizing the light from the first hot cathode tube 17A, and uneven brightness is more suitably suppressed.

The directional reflection surface 25 extends over a range that includes the portion of the reflection sheet overlapping with the first hot cathode tube 17A and is larger than the portion. Thus, the directional reflection surface 25 is provided to include the portion (first light source overlapping reflection portion RA1) overlapping with the first hot cathode tube 17A and extend over a range which is larger than the portion. Accordingly, light from the first hot cathode tube 17A can be more efficiently reflected to the portion (second light source overlapping portion DA2) of the diffuser plate 30 overlapping with the second hot cathode tube 17B by the directional reflection surface 25.

The parallel reflection surface 26 that is parallel to the plate surface of the diffuser plate 30 may be provided on at least the portion (second light source overlapping reflection portion RA2) of the reflection sheet 20 overlapping with the second hot cathode tube 17B. Thus, light reflected by the parallel reflection surface 26 provided on at least the portion (second light source overlapping reflection portion RA2) of the reflection sheet 20 overlapping with the second hot cathode tube 17B is not angled as in the directional reflection surface 25. Therefore, light reflected by the parallel reflection surface 26 is efficiently made incident to the portion (second light source overlapping portion DA2) of the diffuser plate 30 overlapping with the second hot cathode tube 17B without being positively directed toward the portion (first light source overlapping portion DA1) of the diffuser plate 30 overlapping with the first hot cathode tube 17A. Thereby, a more amount of incident light to the portion (second light source overlapping portion DA2) of the diffuser plate 30 overlapping with the second hot cathode tube 17B can be complemented together with the reflected light by the directional reflection surface 25, and uneven brightness can be more effectively suppressed.

The parallel reflection surface 26 is provided to include the portion (second light source overlapping reflection portion RA2) of the reflection sheet 20 overlapping with the second hot cathode tube 17B and extend over a range which is larger than the portion. Thus, the parallel reflection surface 26 is provided to sandwich the portion (second light source overlapping reflection portion RA2) overlapping with the second hot cathode tube 17B and extend over a range which is larger than the portion. Therefore, light from the second hot cathode tube 17B can be more efficiently made incident to the portion (second light source overlapping portion DA2) of the diffuser plate 30 overlapping with the second hot cathode tube 17B by the parallel reflection surface 26.

The directional reflection surface 25 rises toward the light output side from the parallel reflection surface 26. Thus, light in the chassis 14 can be efficiently made incident to the portion (second light source overlapping portion DA2) of the diffuser plate 30 overlapping with the second hot cathode tube 17B by the parallel reflection surface 26 and the directional reflection surfaces 25 rising toward the light output side from the parallel reflection surface 26.

The rising angle of the directional reflection surface 25 from the parallel reflection surface 26 is an acute angle. Thus, light reflected by the directional reflection surface 25 is angled based on the rising angle of the directional reflection surface 25 from the parallel reflection surface 26. The angle is set to the acute angle, and thereby the light can be efficiently made incident by the portion (second light source overlapping portion DA2) of the diffuser plate 30 overlapping with the second hot cathode tube 17B.

The chassis 14 has a portion facing the diffuser plate 30, and the portion is defined into at least a first end portion 14A, a second end portion 14B located at an end opposite to the first end portion 14A, and a center portion 14C sandwiched between the first end portion 14A and the second end portion 14B. The second hot cathode tube 17B is provided on the center portion 14C. The first hot cathode tube 17A is provided on each of the first end portion 14A and the second end portion 14B. The directional reflection surface 25 is provided on each of the portions (rising portions 20b) of the reflection sheet 20 overlapping with the first end portion 14A and the second end portion 14B. The parallel reflection surface 26 is provided on the portion (bottom portion 20a) overlapping with the center portion 14C. Thus, the reflected light can be efficiently made incident to the portion of the diffuser plate 30 overlapping with the above-mentioned center portion 14C by the parallel reflection surface 26 and the directional reflection surface 25. The parallel reflection surface 26 is provided on the portion (bottom portion 20a) overlapping with the center portion 14C of the chassis 14 in which the second hot cathode tube 17B is provided. The directional reflection surface 25 is provided on each of the portions (rising portions 20b) overlapping with the first end portion 14A and the second end portion 14B in each of which the first hot cathode tube 17A is provided. Thereby, sufficient brightness can be ensured in the center portion of the backlight unit 12, and brightness of the display center portion is ensured also in the liquid crystal display device 10 provided with the backlight unit 12, good visibility can be obtained.

The chassis 14 has a shape following a shape of the reflection sheet 20. Thus, the shape of the reflection sheet 20 can be kept by the chassis 14 having the shape following the shape of the reflection sheet 20. Thereby, because the shape of the reflection sheet 20 can be stably kept, the directivity of light reflected thereby can be stabilized. Therefore, the reflection sheet 20 can exhibit desired optical performance.

The distance between the first hot cathode tube 17A and the opposed portion (long side plate 24) of the chassis 14 that is opposed to the first hot cathode tube 17A is almost same as the distance between the second hot cathode tube 17B and the opposed portion (bottom plate 22) of the chassis 14 that is opposed to the second hot cathode tube 17B. Thus, when each hot cathode tube 17 is attached to the chassis 14, for example, a common attaching structure (socket 18) thereof can be used.

The directional reflection surface 25 is inclined with respect to the plate surface of the diffuser plate 30. Thus, light can be efficiently reflected to the portion of the diffuser plate 30 overlapping with the second hot cathode tube 17B by the inclined directional reflection surface 25.

The light source is the hot cathode tube 17. Thus, improved brightness can be achieved.

Although the first embodiment of the present invention has been described, the present invention is not limited to this embodiment and for example, may include the following modification examples. In each of the following modification examples, the same members as those in the above-mentioned embodiment are given the same reference numerals and illustration and description thereof may be omitted.

### First Modification Example of First Embodiment

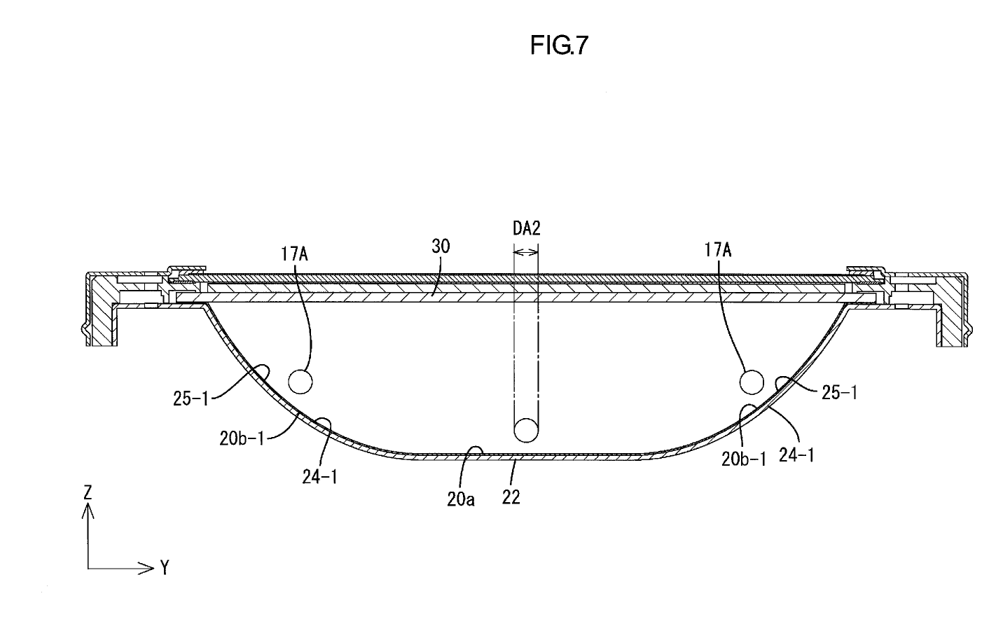

A first modification example of the first embodiment will be described with reference to FIG. 7. In this context, a rising portion 20b-1 and a long side plate 24-1 which have changed shapes are shown. FIG. 7 is a sectional view along a short side direction of a liquid crystal display device according to the present modification example.

As shown in FIG. 7, the rising portion 20b-1 and the long side plate 24-1 have a substantially circular arc (arcuate-shaped) sectional shape along the Y axis direction. For details, the rising portion 20b-1 and the long side plate 24-1 have a substantially circular arc shape curved such that the curved top is close to the back side. The rising portion 20b-1 and the long side plate 24-1 are wholly provided closer to the back side rather than a line (chord) connecting a rising base end and a rising tip end. Rising angles of the rising portion 20b-1 and the long side plate 24-1 from the bottom portion 20a and the bottom plate 22 are almost the same as those of the above-mentioned first embodiment. The rising angle is an angle between a tangent line to the rising base end of the rising portion 20b-1 (the long side plate 24-1) and the bottom portion 20a (the bottom plate 22). A directional reflection surface 25-1 included in the rising portion 20b-1 also has the substantially circular arc shape similar to the rising portion 20b-1 and the long side plate 24-1. Mainly, the directional reflection surface 25-1 can efficiently direct light from the first hot cathode tube 17A toward a second light source overlapping portion DA2 of the diffuser plate 30.

As described above, according to the present modification example, the directional reflection surface 25-1 has a curved shape. Thus, light can be efficiently reflected to the second light source overlapping portion DA2 of the diffuser plate 30 by the directional reflection surface 25-1 having a curved shape.

### Second Modification Example of First Embodiment

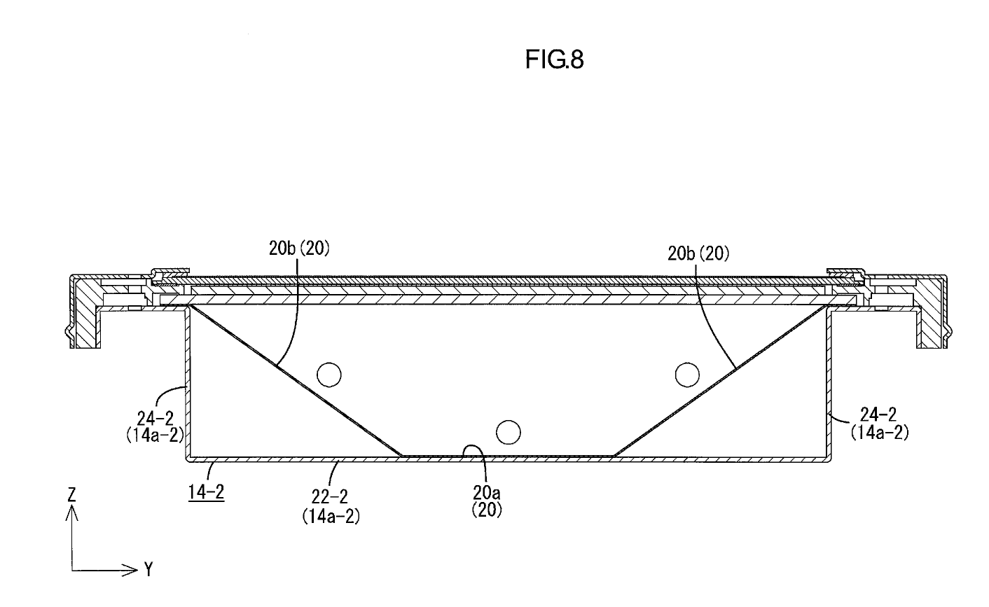

A second modification example of the first embodiment will be described with respect to FIG. 8. In the second modification example, a shape of a chassis 14-2 is changed. FIG. 8 is a sectional view along a short side direction of a liquid crystal display device according to the present modification example.

In the chassis 14-2, an area of a bottom plate 22-2 corresponds to a plan area of the bottom portion 20a and the rising portions 20b of the reflection sheet 20. Both long side plates 24-2 rise from the bottom plate 22-2 at substantially right angles. That is, a housing portion 14a-2 of the chassis 14-2 according to the present modification example has a substantially box-shape having a certain depth over the entire area. A shape of the housing portion 14a-2 does not correspond to an outer shape of the reflection sheet 20. Therefore, a predetermined space is generated between the bottom plate 22-2, the side plate 24-2, and the rising portion 20b.

### Third Modification Example of First Embodiment

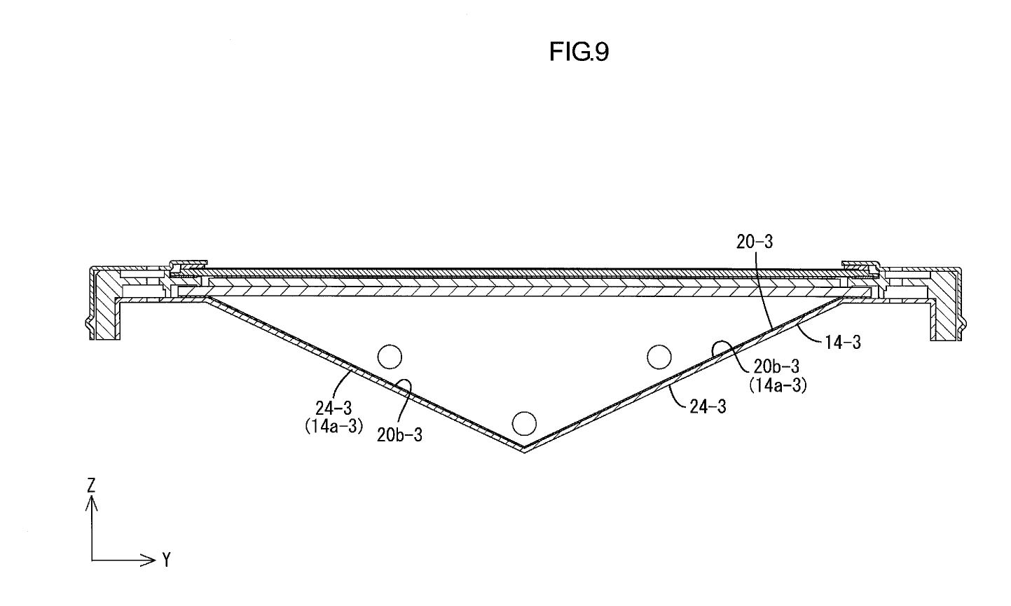

A third modification example of the first embodiment will be described with reference to FIG. 9. In the third modification example, shapes of a chassis 14-3 and a reflection sheet 20-3 are changed. FIG. 9 is a sectional view of a liquid crystal display device along a short side direction according to the present modification example.

As shown in FIG. 9, a housing portion 14a-3 of the chassis 14-3 according to the present modification example is obtained by directly connecting a pair of long side plates 24-3 to each other. The bottom plate 22 shown in the above-mentioned first embodiment is not provided. Similarly, the reflection sheet 20-3 is formed by directly connecting a pair rising portions 20b-3 to each other. The bottom portion 20a and the parallel reflection surface 26 that are shown in the above-mentioned first embodiment are not provided.

### Second Embodiment

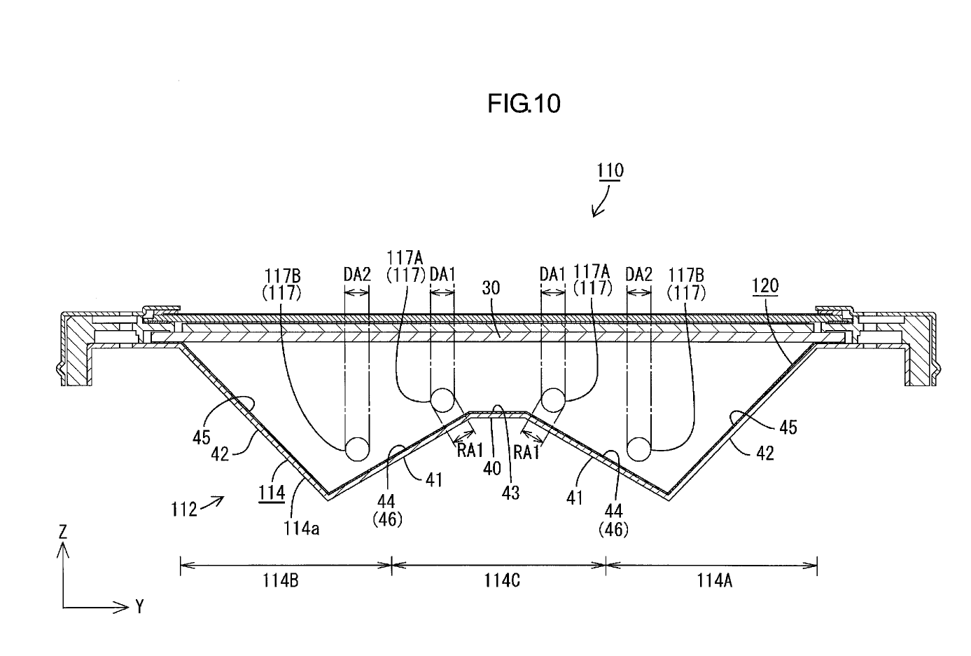

A second embodiment of the present invention will be described with reference to FIG. 10. In the second embodiment, shapes of a chassis 114 and a reflection sheet 120 are changed, and an arrangement and the number of hot cathode tubes 117 are changed. Overlapping description of the same configuration, operations and effects as those in the first embodiment is omitted. FIG. 10 is a sectional view of a liquid crystal display device along a short side direction according to the present embodiment.

As shown in FIG. 10, a housing portion 114a of the chassis 114 includes a bottom plate 40 provided at a center of a short side direction, a pair of inclined plates 41 bent toward the back side from both ends of the bottom plate 40, and side plates 42 bent toward the front side from one tip end portion of each of the inclined plates 41. The inclined plate 41 is inclined with respect to the bottom plate 40 that is parallel to the plate surface of the diffuser plate 30. The chassis 114 is defined into a first end portion 114A, a second end portion 114B located at an end opposite to the first end portion 114A, and a center portion 114C sandwiched therebetween in the short side direction (Y axis direction) thereof. In this case, the center portion 114C corresponds to the bottom plate 40 and apart of the inclined plates 41 (a portion close to the bottom plate 40). Each of the first end portion 14A and the second end portion 14B corresponds to a part of the inclined plate 41 (a portion close to the side plate 42) and each of the side plates 42.

The reflection sheet 120 has a shape following a shape of the above-mentioned housing portion 114a. That is, the reflection sheet 120 includes a bottom portion 43, inclined portions 44 bent toward the back side from ends of the bottom portion 43, and side portions 45 bent toward the front side from one tip end portion of each of the inclined portions 44. On the other hand, the two hot cathode tubes 117 are attached for each of the inclined plates 41 of the chassis 114. That is, the four hot cathode tubes 117 in total are attached. A distance between each of the four hot cathode tubes 117 and the diffuser plate 30 is set to two different distances. For details, a first hot cathode tube 117A provided close to the bottom plate 40 of each inclined plate 41, that is, close to the center portion is relatively close to the diffuser plate 30. On the other hand, a second hot cathode tube 117B provided close to the side plate 42 of each inclined plate 41, that is, close to the end side is relatively far from the diffuser plate 30. The first hot cathode tubes 117A are provided in the center portion 114C of the chassis 114. The second hot cathode tube 117B is provided in each of the first end portion 114A and the second end portion 114B. Corresponding thereto, a pair of first light source overlapping portions DA1 of the diffuser plate 30 is provided in the center portion in the Y axis direction. The second light source overlapping portion DA2 is provided on each of the two ends. Each inclined portion 44 of the reflection sheet 120 has a directional reflection surface 46 facing the second light source overlapping portion DA2 of the diffuser plate 30 over its entire area. The directional reflection surface 46 is formed in a portion including the first light source overlapping reflection portion RA1 overlapping with at least the first hot cathode tube 117A, and can efficiently reflect light from the first hot cathode tube 117A to the second light source overlapping portion DA2.

As described above, according to the present embodiment, the chassis 114 has a portion facing the diffuser plate 30 that is defined into at least the first end portion 114A, the second end portion 114B located at an end opposite to the first end portion 114A, and the center portion 114C sandwiched between the first end portion 114A and the second end portion 114B. The first hot cathode tubes 117A are provided in center portion 114C. The second hot cathode tube 117B is provided in each of the first end portion 114A and the second end portion 114B. The directional reflection surfaces 46 are provided on the portions (inclined portions 44) of the reflection sheet 120 overlapping with the center portion 114C. Thus, because the first hot cathode tube 117A relatively close to the diffuser plate 30 is provided on the center portion 114C of the chassis 114, sufficient brightness can be ensured in the center portion of a backlight unit 112. Thereby, brightness of the display center portion of a liquid crystal display device 110 including the backlight unit 112 is ensured and accordingly, good visibility can be obtained. Light from the first hot cathode tube 117A is reflected by the directional reflection surface 46 provided in the portion overlapping with the center portion 114C in which the first hot cathode tube 117A is provided, and thereby the light can be directed toward the portion (second light source overlapping portion DA2) of the diffuser plate 30 overlapping with the first end portion 114A and the second end portion 114B. Therefore, light can be supplied to the portion.

Although the second embodiment of the present invention has been described, the present invention is not limited to this embodiment and for example, may include the following modification examples. In each of the following modification examples, the same members as those in the above-mentioned embodiment are given the same reference numerals and illustration and description thereof may be omitted.

### First Modification Example of Second Embodiment

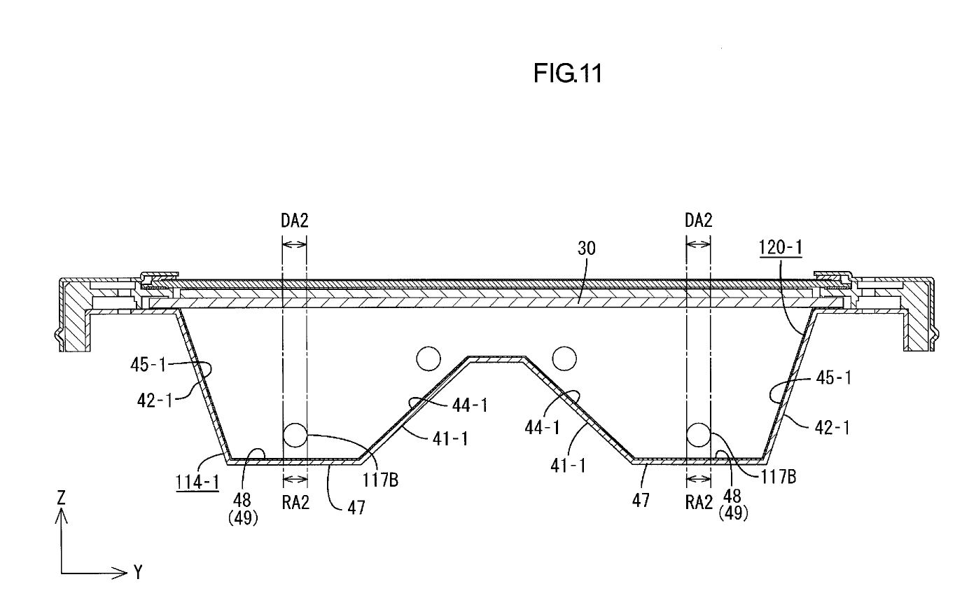

A first modification example of the second embodiment will be described with reference to FIG. 11. In the first modification, shapes of a chassis 114-1 and a reflection sheet 120-1 are changed. FIG. 11 is a sectional view of a liquid crystal display device along a short side direction according to the present modification example.

A second bottom plate 47 which is parallel to the plate surface of the diffuser plate 30 and a bottom plate 40-1 is provided between an inclined plate 41-1 and a side plate 42-1 of the chassis 114-1. A second bottom portion 48 that is parallel to the second bottom plate 47 is provided between an inclined portion 44-1 and a side portion 45-1 of the reflection sheet 120-1. The second bottom portion 48 has a parallel reflection surface 49 that is parallel to the plate surface of the diffuser plate 30 over its entire area. The parallel reflection surface 49 is formed in a portion including the second light source overlapping reflection portion RA2 overlapping with at least the second hot cathode tube 117B, and can efficiently reflect light in the chassis 114-1 to the second light source overlapping portion DA2 together with a directional reflection surface 46-1. Therefore, a higher effect of suppressing uneven brightness can be obtained as compared with the second embodiment that does not have the parallel reflection surface 49.

### Third Embodiment

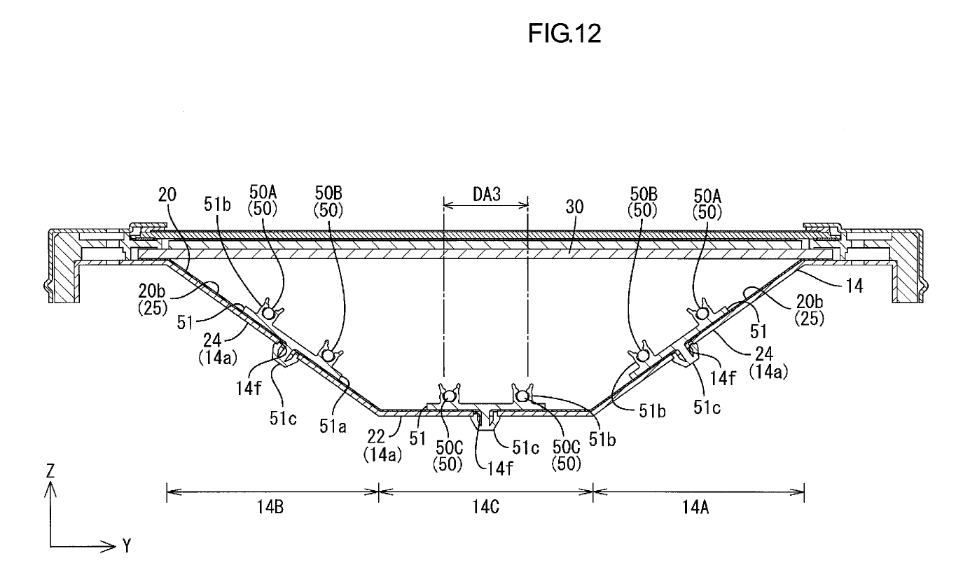

A third embodiment of the present invention will be described with reference to FIG. 12. In the third embodiment, a cold cathode tube 50 is used as a light source, and a light source holding member 51 is provided. Overlapping description of the same configuration, actions and effects as those in the first embodiment is omitted. FIG. 12 is a sectional view of a liquid crystal display device along a short side direction according to the present embodiment.

In the present embodiment, as shown in FIG. 12, a cold cathode tube 50 as a light source (line light source) has a tubular (linear) shape. The cold cathode tube 50 includes a hollow long glass tube having sealed both ends, and a pair of electrodes each of which is enclosed in each of the ends of the glass tube. A fluorescent material is coated over an inner wall surface of the glass tube and mercury and rare gas or the like are enclosed in the glass tube. Relay connectors (not shown) are respectively provided on both ends of the cold cathode tube 50. The relay connector is connected to a lead terminal projected to the outside of the glass tube from the electrode. The cold cathode tube 50 is connected to an inverter board (not shown) attached to the outer surface side of the chassis 14 via the relay connector, to control the drive of the inverter board. An outer diameter size of the cold cathode tube 50 is smaller than an outer diameter size (for example, about 15.5 mm) of the hot cathode tube 17 shown in the above-mentioned first embodiment. For example, the outer diameter size is about 4 mm.

The six cold cathode tubes 50 having the above-mentioned structure are housed in the chassis 14 with a length direction (axial direction) thereof aligned with a long side direction of the chassis 14. For details, a set of the two cold cathode tubes 50 is provided in each of the first end portion 14A, the second end portion 14B, and the center portion 14C of the chassis 14. That is, the two cold cathode tubes 50 are attached to each of the bottom plate 22 and the side plates 24 included in the housing portion 14a. A distance between one of the two cold cathode tubes 50 attached to each side plate 24 and the diffuser plate 30 is different from a distance between the other one of the two cold cathode tubes 50 and the diffuser plate 30. The cold cathode tube relatively close to the diffuser plate 30 is defined as a first cold cathode tube 50A. The cold cathode tube relatively far from the diffuser plate 30 is a second cold cathode tube 50B. On the other hand, a distance between one of the two cold cathode tubes 50 attached to the bottom plate 22 and the diffuser plate 30 may be equal to that between the other and the diffuser plate 30. In this case, however, the two cold cathode tubes 50 attached to the bottom plate 22 are farthest from the diffuser plate 30 as compared with the above-mentioned first cold cathode tube 50A and second cold cathode tube 50B, and are defined as third cold cathode tubes 50C. In the present embodiment, the first cold cathode tubes 50A and the second cold cathode tubes 50B correspond to “short-distance light sources”. The third cold cathode tubes 50C correspond to “long-distance light sources”. The directional reflection surfaces 25 included in the rising portions 20b of the reflection sheet 20 can mainly reflect light from the first cold cathode tube 50A and the second cold cathode tube 50B, and direct the light toward a third light source overlapping portion DA3 (long-distance light source overlapping portion) of the diffuser plate 30 overlapping with the third cold cathode tubes 50C.

The light source holding members 51 holding the cold cathode tubes 50 are attached to the bottom plate 22 and the side plates 24 of the chassis 14. The light source holding member 51 includes a body portion 51a, a light source holding portion 51b and an attaching portion 51c. The body portion 51a is configured to sandwich the bottom portion 20a or the rising portion 21a with the bottom plate 22 or each side plate 24. The light source holding portion 51b is projected to the front side from the body portion 51a and configured to hold the cold cathode tube 50. The attaching portion 51c is projected to the back side from the body portion 51a and attached to the bottom plate 22 or each side plate 24. The two light source holding portions 51b are arranged in parallel at a predetermined interval in the Y axis direction in the body portion 51a. An arrangement interval between the two light source holding portions 51b is the same as that between the cold cathode tubes 50. The Light source holding portion 51b has a pair of arm portions. The cold cathode tube 50 is detached from or attached to the light source holding portion via a gap formed between tip end portions of the arm portions. The arm portions can be elastically deformed to open outward in attaching and detaching of the cold cathode tube 50. The cold cathode tube 50 can be elastically held between the arm portions. The cold cathode tube 50 can be kept in a straight state in the axial direction by the light source holding portion 51b, and a positional relationship of the cold cathode tube 50, the diffuser plate 30, and the reflection sheet 20 in the Z axis direction can be constantly maintained. The attaching portions 51c are inserted into and locked by attaching holes 14f formed in the bottom plate 22 and the side plates 24 of the chassis 14, and thereby the light source holding member 51 can be kept in an attaching state to the chassis 14. The reflection sheet 20 has insertion holes into which the attaching portions 51c are inserted.

As described above, according to the present embodiment, the light source holding members 51 configured to hold the cold cathode tubes 50 are attached to the chassis 14. The chassis 14 has a shape following a shape of the reflection sheet 20 and therefore, the light source holding members 51 can be easily attached to the chassis 14 irrespective of the shape of the reflection sheet 20 even when the reflection sheet 20 is sandwiched between the light source holding member 51 and the chassis 14.

The cold cathode tube 50 is used as the light source and this extends life of the light source, and dimming of light can be easily performed.

### Fourth Embodiment

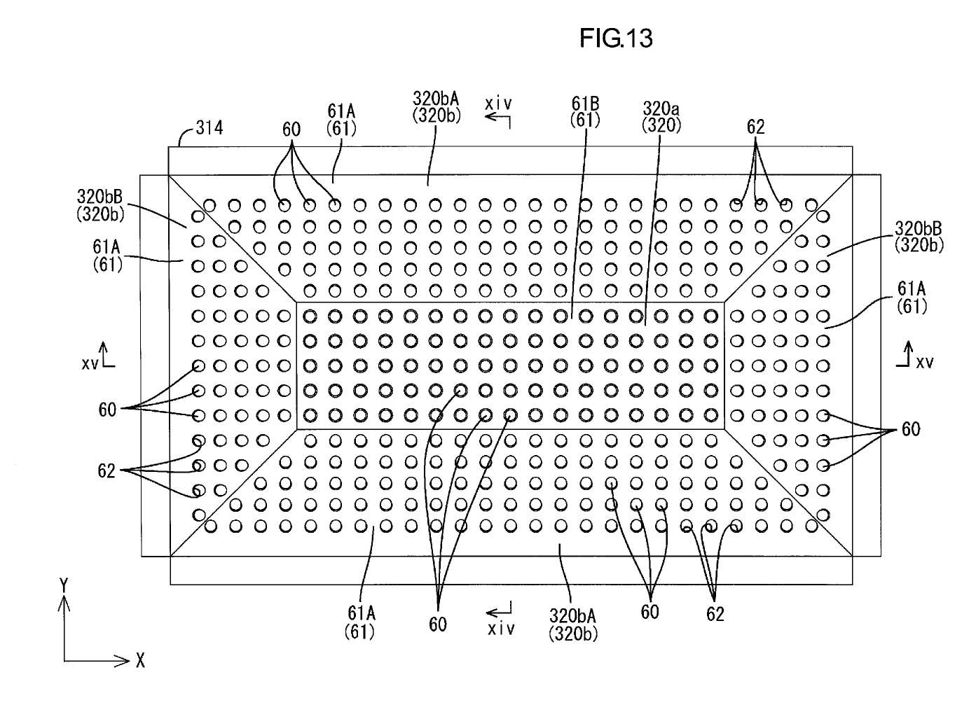

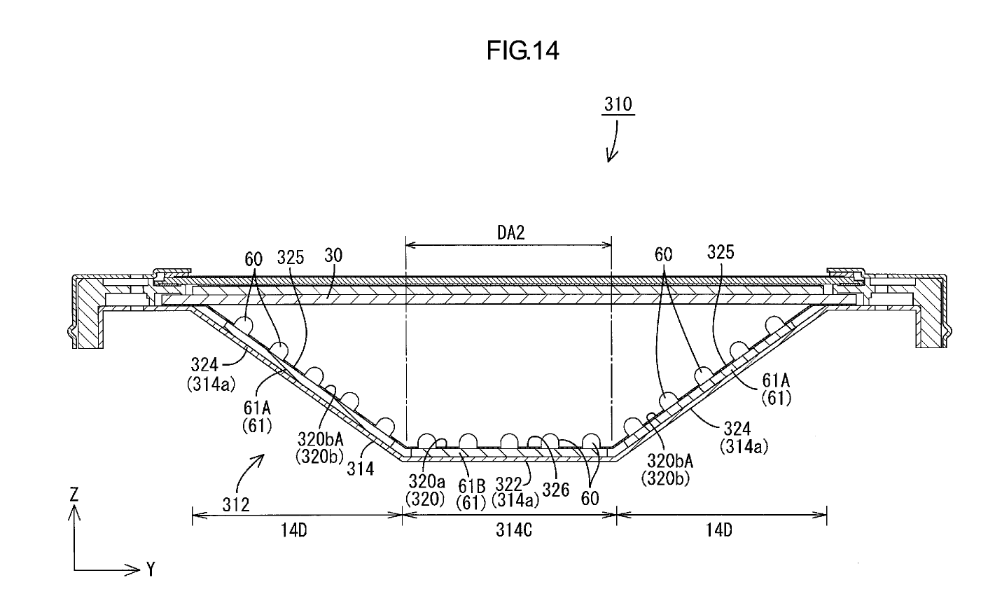

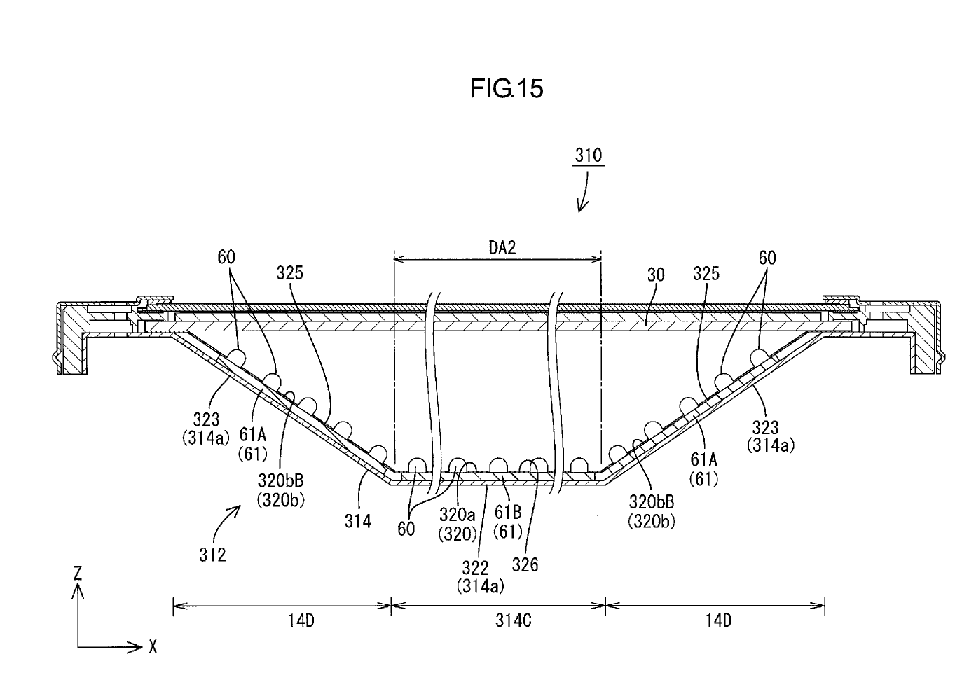

A fourth embodiment of the present invention will be described with reference to FIGS. 13 to 15. In the fourth embodiment, an LED board 61 on which LEDs 60 are mounted is used as a light source, and shapes of a chassis 314 and a reflection sheet 320 are changed. Overlapping description of the same configuration, operations and effects as those in the first embodiment is omitted. FIG. 13 is a plan view showing an arranging configuration of an LED board and a reflection sheet in a chassis. FIG. 14 is a xiv-xiv line sectional view of FIG. 13. FIG. 15 is a xv-xv line sectional view of FIG. 13.

Shapes of the chassis 314 and the reflection sheet 320 will be described. As shown in FIGS. 13 to 15, in a housing portion 314a of the chassis 314, long side plates 324 and short side plates 323 rise so as to be inclined to the front side from the bottom plate. The housing portion 314a is formed in substantially a bowl as a whole. Therefore, a bottom plate 322 of the chassis 314 is a center portion 314C, and the long side plates 324 and the short side plates 323 surrounding the bottom plate 322 form a frame-like portion 14D surrounding the center portion 314C. The reflection sheet 320 has a shape following a shape of the above-mentioned housing portion 314a. A rising portion 320b includes a pair of first rising portions 320bA rising to the front side from ends of the long sides of a bottom portion 320a, and a pair of second rising portions 320bB rising to the front side from ends of the short sides of the bottom portion 320a. Each of the first rising portions 320bA and each of the second rising portions 320bB adjacent to each other are connected to each other.

The LEDs 60 are a so-called surface-mounting type and the LEDs 60 are mounted on the LED board 61. The LEDs 60 are arranged in parallel in a grid pattern (in a matrix) in the X-axis direction and the Y axis direction on the front side surface of the LED board 61. Each LED 60 is configured by sealing an LED chip on a base board fixed to the LED board 61 with a resin material. Three kinds of LED chips mounted on the board portion have different main light emitting wavelengths. Specifically, the LED chips emit R (red), G (green), and B (blue) single colors. Each LED 60 is a top type having a light-emitting surface opposite to a mounting surface to the LED board 61. The LED board 61 is made of a synthetic resin. Five LED boards 61 in total are provided to correspond to the bottom plate 322 and the side plates 323, 324 of the chassis 14. The LED boards 61 are fixed to the plates 322 to 324 by fixing means not shown. Each LED board 61 has a planar shape corresponding to each of the plates 322 to 324 to be attached. A wiring pattern including a metal film is formed on the LED board 61, and each LED 60 is mounted in a predetermined position. An external control board not shown is connected to the LED board 61. Electric power required for lighting the LED 60 is supplied therefrom, and the drive of the LED 60 can be controlled.

The LED board 61 attached to each of the side plates 323, 324 is defined as a first LED board 61A (short-distance light source) relatively close to the diffuser plate 30. The LED board 61 attached to the bottom plate 322 is defined as a second LED board 61B (long-distance light source) relatively far from the diffuser plate 30. The bottom portion 320a of the reflection sheet 320 covering these LED boards 61 from the front side is overlapping with the second LED board 61B, and has a parallel reflection surface 326. The rising portions 320bA and 320bB are overlapping with the first LED boards 61A, and have directional reflection surfaces 325. Thereby, light from each first LED board 61A provided so as to surround the second LED board 61B is reflected to the second light source overlapping portion DA2 (long-distance light source overlapping portion) of the diffuser plate 30 overlapping with the second LED board 61B provided on the center portion 314C of the chassis 314 by each directional reflection surface 325 similarly provided so as to surround the second LED board 61B, and the incidence thereof is accelerated. Thereby, a sufficient amount of incident light can be ensured, and uneven brightness can be effectively suppressed. The reflection sheet 320 has insertion holes 62 through which the LEDs 60 are inserted. The insertion holes 62 are formed in a substantially grid pattern in positions corresponding to the LEDs 60.

As described above, according to the present embodiment, the chassis 314 has a portion facing the diffuser plate 30 that is defined into at least the center portion 314C and the frame-like portion 14D surrounding the center portion 314C. The second LED board 61B is provided in the center portion 314C. On the other hand, the first LED boards 61A are provided in the frame-like portion 14D. The directional reflection surfaces 325 are provided in the portions of the reflection sheet 320 overlapping with the frame-like portion 14D. On the other hand, the parallel reflection surface 326 is provided on the portion overlapping with the center portion 314C. Thus, reflected light can be efficiently made incident to the portion (second light source overlapping portion DA2) of the diffuser plate 30 overlapping with the above-mentioned center portion 314C by the parallel reflection surface 326 and the directional reflection surfaces 325. The parallel reflection surface 326 is provided in the portion of the chassis 314 overlapping with the center portion 314C on which the second LED board 61B is provided. The directional reflection surfaces 325 are provided in the portions overlapping with the frame-like portion 14D that surrounds the center portion 314C and has the first LED boards 61A thereon. Thereby, sufficient brightness can be ensured for the center portion of a backlight unit 312, and brightness of the display center portion is ensured also in a liquid crystal display device 310 provided with the backlight unit 312 and accordingly, good visibility can be obtained.

The light source is an LED board 61 on which a plurality of LEDs 60 is mounted. This extends life of the light source and lowers power consumption and the like.

### Other Embodiments

The present invention is not limited to the embodiments described in the above description and figures, and for example, following embodiments fall within the technical scope of the present invention.

(1) The angle of the directional reflection surface to the plate surface of the diffuser plate other than ones shown in the above-mentioned embodiments can be suitably changed. The angle is preferably an acute angle.

(2) The directional reflection surface is formed so as to have an area greater than the portion of the reflection sheet overlapping with the short-distance light source in the above-mentioned embodiments. However, the present invention includes also a directional reflection surface having an area substantially equal to an area of the portion overlapping with the short-distance light source. A directional reflection surface may not be provided on the portion overlapping with the short-distance light source but provided on the portion that does not overlap with the short-distance light source.

(3) The parallel reflection surface is formed so as to have an area greater than the portion of the reflection sheet overlapping with the long-distance light source in the above-mentioned embodiments. However, a parallel reflection surface may have an area substantially equal to that of the portion overlapping with the long-distance light source. A parallel reflection surface may not be provided on the portion overlapping with the long-distance light source but provided on the portion that does not overlap with the long-distance light source.

(4) Two or three different distances are provided between the light source and the optical member in the above-mentioned embodiments. However, four or more different distances maybe provided between the light source and the optical member.

(5) The number of the light sources housed in the chassis other than the above-mentioned embodiments can suitably be changed.

(6) In the above-mentioned first embodiment, the long side plate of the chassis is formed in an inclined shape, and the rising portion (directional reflection surface) is formed on the reflection sheet so as to correspond to the side plate. However, for example, the short side plate of the chassis may be formed in an inclined shape, and the rising portion (directional reflection surface) may be formed on the reflection sheet so as to correspond to the short side plate.

(7) The directional reflection surface has a circular-arch shape in the above-mentioned first modification example of the first embodiment. However, for example, the directional reflection surface may have a curved shape such as a wave shape.

(8) The technique described in the above-mentioned first modification example of the first embodiment, that is, the technique for forming the directional reflection surface in a curved shape can also be applied to the third modification example of the first embodiment, and the second to fourth embodiments.

(9) The technique described in the above-mentioned second modification example of the first embodiment, that is, the technique for making the shape of the chassis different from that of the reflection sheet can also be applied to the other modification example of the first embodiment, and the second to fourth embodiments.

(10) As in the above-mentioned fourth embodiment, in the backlight unit that has the chassis and the reflection sheet formed in substantially a bowl shape, the hot cathode tube or the cold cathode tube can also be used as the light source.

(11) The front side of the LED board is covered with the reflection sheet as a separate component in the above-mentioned fourth embodiment. However, for example, a white light reflection layer can also be formed on the surface of the LED board, which can be used as the “reflection member”.

(12) The chassis made of the synthetic resin is used in the above-mentioned embodiments. However, the present invention can also be applied to a metal chassis.

(13) The hot cathode tube or the cold cathode tube that is a kind of fluorescent tube (line light source) is used as the light source in the above-mentioned first to third embodiments. However, the present invention includes also the other kinds of fluorescent tubes. The present invention includes also discharge tubes (mercury lamp or the like) of kinds other than the fluorescent tube.

(14) The LED that is a kind of point light source as the light source is used in the above-mentioned fourth embodiment. However, the present invention includes also point light sources of other kinds. A planar light source such as an organic EL may be adopted.

(15) A kind of light source is used in the above-mentioned embodiments. However, the present invention includes also a plurality of kinds of light sources mixedly used. Specifically, the hot cathode tube and the cold cathode tube may be mixed; the hot cathode tube and the LED may be mixed; the cold cathode tube and the LED may be mixed; or the hot cathode tube, the cold cathode tube, and the LED may be mixed.

(16) Also in embodiments other than each of the above-mentioned embodiments, screen size and aspect ratio of the liquid crystal display device can be changed as appropriate.

(17) Although the liquid crystal panel and the chassis are arranged in the longitudinally mounted state so that the short-side direction matches the vertical direction in each of the above-mentioned embodiments, the configuration in which the liquid crystal panel and the chassis are arranged in the longitudinally mounted state so that the long-side direction matches the vertical direction also falls within the scope of the present invention.

(18) Although the TFT is used as the switching component of the liquid crystal display device in each of the above-mentioned embodiments, the present invention can also be applied to a liquid crystal display device using a switching component (for example, a thin film diode (TFD)) other than TFT and the monochrome liquid crystal display device other than the color liquid crystal display device.

(19) Although the liquid crystal display device using the liquid crystal panel as the display panel is illustrated in each of the above-mentioned embodiments, the present invention can be applied to a display device using the other type of display panel.

(20) Although the television receiver having a tuner is illustrated in each of the above-mentioned embodiments, the present invention can be applied to a display device having no tuner.

1. A lighting device comprising:
light sources;
a chassis configured to house the light source therein and from which light from the light source exits;
an optical member provided on a light output side with respect to the light source; and
a reflection member provided to face the optical member in the chassis and configured to reflect the light, wherein:
the light sources include at least a short-distance light source relatively close to the optical member and a long-distance light source relatively far from the optical member, and a distance between the short-distance light source and the optical member is different from that between the long-distance light source and the optical member; and
the lighting device further includes a directional reflection surface provided on a portion of the reflection member that does not overlap with at least the long-distance light source, the directional reflection surface facing toward a portion of the optical member overlapping with the long-distance light source.

2. The lighting device according to claim 1, wherein the directional reflection surface is provided on at least a portion of the reflection member overlapping with the short-distance light source.

3. The lighting device according to claim 2, wherein the directional reflection surface extends over a range of the reflection member which is larger than the portion of the reflection member overlapping with the short-distance light

4. The lighting device according to claim 1, further comprising a parallel reflection surface provided on a portion of the reflection member that overlaps with the long-distance light source, the parallel reflection surface being parallel to a plate surface of the optical member.

5. The lighting device according to claim 4, wherein the parallel reflection surface extends over a range of the reflection member that is larger than the portion of the reflection member overlapping with the long-distance light source with having the portion therein.

6. The lighting device according to claim 4, wherein the directional reflection surface is configured to rise toward the light output side from the parallel reflection surface.

7. The lighting device according to claim 6, wherein the directional reflection surface has an acute rising angle to the parallel reflection surface.

8. The lighting device according to claim 4, wherein:
the chassis has a portion facing the optical member, the portion being defined into at least a first end portion, a second end portion located at an end opposite to the first end portion, and a center portion sandwiched between the first end portion and the second end portion;
the center portion includes the long-distance light source;
the first end portion and the second end portion each includes the short-distance light source;
the directional reflection surface is provided on each of the portions of the reflection member overlapping with the first end portion and the second end portion respectively; and
the parallel reflection surface is provided on the portion of the reflection member overlapping with the center portion.

9. The lighting device according to claim 4, wherein:
the chassis has a portion facing the optical member, the portion being defined into at least a center portion and a frame-like portion surrounding the center portion;
the center portion includes the long-distance light source;
the frame-like portion includes the short-distance light source;
the directional reflection surface is provided on a portion of the reflection member overlapping with the frame-like portion; and
the parallel reflection surface is provided on a portion of the reflection member overlapping with the center portion.

10. The lighting device according to claim 1, wherein:
the chassis has a portion facing the optical member, the portion being defined into at least a first end portion, a second end portion located at an end opposite to the first end portion, and a center portion sandwiched between the first end portion and the second end portion;
the center portion includes the long-distance light source;
the first end portion and second end portion each include the short-distance light source; and
the directional reflection surface is provided on each of the portions of the reflection member overlapping with the first end portion and the second end portion respectively.

11. The lighting device according to claim 1, wherein:
the chassis has a portion facing the optical member, the portion being defined into at least a first end portion, a second end portion located at an end opposite to the first end portion, and a center portion sandwiched between the first end portion and the second end portion;
the center portion includes the short-distance light source;
the first end portion and the second end portion each include the long-distance light source; and
the directional reflection surface is provided on the portion of the reflection member overlapping with the center portion.

12. The lighting device according to claim 1, wherein the chassis has a shape following a shape of the reflection member.

13. The lighting device according to claim 12, wherein a distance between the short-distance light source and a portion of the chassis facing the short-distance light source is substantially equal to a distance between the long-distance light source and a portion of the chassis facing the long-distance light source.

14. The lighting device according to claim 12, wherein the chassis includes a light source holding member configured to hold the light source.

15. The lighting device according to claim 1, wherein the directional reflection surface is inclined with respect to a plate surface of the optical member.

16. The lighting device according to claim 1, wherein the directional reflection surface has a curved shape.

17. The lighting device according to claim 1, wherein the light source is a hot cathode tube.

18. The lighting device according to claim 1, wherein the light source is a cold cathode tube.

19. The lighting device according to claim 1, wherein the light source is an LED board on which a plurality of LEDs is mounted.

20. A display device comprising:
the lighting device according to claim 1; and
a display panel performing display by use of light from the lighting device.

21. The display device according to claim 20, wherein the display panel is a liquid crystal panel configured by filling a liquid crystal between a pair of substrates.

22. A television receiver comprising the display device according to claim 20.
